(19) United States
(12) Patent Application Publication
(10) Pub. No.: US 2019/0258123 A1
(43) Pub. Date: Aug. 22, 2019

(54) DISPLAY PANEL, DISPLAY APPARATUS AND DRIVING METHOD THEREOF

(71) Applicants: Chongqing BOE Optoelectronics Technology Co., Ltd., Chongqing (CN); BOE Technology Group Co., Ltd., Beijing (CN)

(72) Inventors: Yanli Zhao, Beijing (CN); Xiaoji Li, Beijing (CN); Changgong Zhu, Beijing (CN); Jianghong Wen, Beijing (CN); Xiaolong Liu, Beijing (CN); Wenhao You, Beijing (CN); Xiuzhu Tang, Beijing (CN)

(21) Appl. No.: 16/342,396

(22) PCT Filed: Aug. 22, 2018
(86) PCT No.: PCT/CN2018/101716

§ 371 Date: Apr. 16, 2019

(30) Foreign Application Priority Data
Sep. 28, 2017 (CN) 201710900778.1

(51) Int. Cl. G02F 1/1343; G02F 1/1362; G02F 1/1333

(52) U.S. Cl. CPC G02F 1/134309; G02F 2201/123; G02F 1/133345; G02F 1/136209

(57) ABSTRACT

The present disclosure provides a display panel. The display panel of the present disclosure includes: a first substrate and a second substrate disposed opposite to each other, and a liquid crystal layer disposed between the first substrate and the second substrate; wherein the first substrate is divided into a plurality of pixel regions, and the pixel regions include a central region and a peripheral region, a first electrode and a second electrode are sequentially disposed on a surface of the first substrate facing the liquid crystal layer in a direction from the first substrate to the liquid crystal layer; the first electrode and the second electrode are configured to form an electric field under a voltage to drive liquid crystal molecules in the liquid crystal layer to deflect; and an edge electrode disposed on the second substrate, wherein the orthographic projection of the edge electrode on the first substrate at least partially overlaps the peripheral region. The present disclosure also provides a display apparatus including the above display panel.

### CROSS REFERENCE OF RELATED APPLICATIONS

This application is a Section 371 National Stage application of International Application No. PCT/CN2018/101716, filed on 22 Aug. 2018, which published as WO 2019/062395 A1 on 4 Apr. 2019, and claims priority to Chinese patent application No. 201710900778.1, entitled “Display Panel and Display Apparatus”, and filed to CNIPA on Sep. 28, 2017, the contents of which are hereby incorporated by reference in their entireties.

### TECHNICAL FIELD

The present disclosure belongs to the field of display technology, and in particular to a display panel and a display apparatus.

### BACKGROUND

A Thin Film Transistor Liquid Crystal Display (TFT-LCD) is an important type of flat panel display device. According to the direction of the electric field driving the liquid crystal, the TFT-LCD can be classified into a vertical electric field type and a horizontal electric field type. The vertical electric field type needs to form a pixel electrode on an array substrate and a common electrode on a color filter (CF) substrate, such as in the commonly used TN mode. The horizontal electric field type needs to simultaneously form a pixel electrode and a common electrode on an array substrate, such as in the ADS mode (Advanced Super Dimension Switch mode). ADS refers to the advanced super-dimension switch technology, which is a planar electric field wide viewing angle core technology. Its essential technical characteristics are described as: the electric field generated by edges of slit electrodes in the same plane and the electric field generated between a slit electrode layer and a plate electrode layer form a multi-dimensional electric field, so that the oriented liquid crystal molecules between the slit electrodes in a liquid crystal cell and the oriented liquid crystal molecules directly above the electrodes can be deflected, thereby improving the liquid crystal operation efficiency and increasing the light transmission efficiency. The advanced super-dimensional switch technology can improve the picture quality of TFT-LCD products, with advantages such as high resolution, high transmittance, low power consumption, wide viewing angle, high aperture ratio, low chromatic aberration, push-Mura free, etc.

### SUMMARY

According to a first aspect of the present disclosure, a display panel is provided, which comprises: a first substrate and a second substrate disposed opposite to each other, and a liquid crystal layer disposed between the first substrate and the second substrate; wherein the first substrate is divided into a plurality of pixel regions, and the pixel regions include a central region and a peripheral region, a first electrode and a second electrode are sequentially disposed on a surface of the first substrate facing the liquid crystal layer in a direction from the first substrate to the liquid crystal layer; the first electrode and the second electrode are configured to form an electric field under a voltage to drive liquid crystal molecules in the liquid crystal layer to deflect; and an edge electrode disposed on the second substrate, wherein the orthographic projection of the edge electrode on the first substrate at least partially overlaps the peripheral region.

According to an embodiment of the present disclosure, the edge electrode is configured to be applied with the same voltage as the first electrode when the display panel is in a gray scale display state; and the edge electrode is configured to be applied with a voltage different from the first electrode when the display panel is in a black display state.

According to an embodiment of the present disclosure, the display panel further comprises: a black matrix disposed on the second substrate, wherein the orthographic projection of the black matrix on the first substrate is between adjacent pixel regions, and the edge electrode is located on a side of the black matrix near the central region; and the spacing between the edge electrode and the black matrix is 0˜60 μm.

According to an embodiment of the present disclosure, the first electrode is a plate electrode, and the second electrode is a strip electrode.

According to an embodiment of the present disclosure, the edge electrode is a plate electrode.

According to an embodiment of the present disclosure, an insulating layer is further disposed between the first electrode and the second electrode.

According to an embodiment of the present disclosure, the insulating layer has a thickness of 0.1˜1 μm.

According to an embodiment of the present disclosure, the insulating layer is a dielectric having a dielectric constant greater than 3.7.

According to an embodiment of the present disclosure, the insulating layer is made of a material comprising a mixture of Barium Titanate and Polyimide.

According to an embodiment of the present disclosure, the display panel further comprises: a first polarizer and a second polarizer respectively disposed on a side of the first substrate and a side of the second substrate opposite to the liquid crystal layer, wherein the first polarizer and the second polarizer have light absorption axes that perpendicular to each other.

According to an embodiment of the present disclosure, the display panel further comprises: a first orientation layer and a second orientation layer in contact with the liquid crystal layer, wherein the first orientation layer is disposed on a side of the second substrate facing the liquid crystal layer, the second orientation layer is disposed on a side of the first substrate facing the liquid crystal layer, and wherein the first orientation layer and the second orientation layer have parallel orientations.

According to an embodiment of the present disclosure, the edge electrode covers the pixel regions.

According to an embodiment of the present disclosure, the edge electrode is made of a material comprising ITO.

According to an embodiment of the present disclosure, the first substrate is an array substrate, and the second substrate is a color filter substrate.

According to a second aspect of the present disclosure, there is provided a display apparatus comprising the above display panel.

According to a third aspect of the present disclosure, a driving method for a display panel is provided, which comprises, when the display panel is in a gray scale display state: applying a first voltage to the first electrode and applying a second voltage to the second electrode, wherein the difference between the first voltage and the second voltage is a display voltage; and applying the first voltage to the edge electrode.

According to an embodiment of the present disclosure, the driving method further comprises, when the display panel is in a black display state: applying the same voltage to the first electrode and the second electrode; and applying, to the edge electrode, a voltage different from the voltage applied to the first electrode.

### BRIEF DESCRIPTION OF THE DRAWINGS

FIG. 1 is a schematic diagram of a pixel region in a display panel according to an embodiment of the present disclosure;

FIG. 2 is a cross-sectional view taken along line A-A′ of FIG. 1;

FIG. 3 is a schematic diagram of a display panel in a normal display state according to an embodiment of the present disclosure;

FIG. 4 is a schematic diagram of a display panel in a black display state according to an embodiment of the present disclosure; and

FIG. 5 is a flow chart of a driving method according to an embodiment of the present disclosure.

### DETAILED DESCRIPTION

The present disclosure will be further described in detail below with reference to the accompanying drawings and particular embodiments in order that one with ordinary skills in the art can have a better understanding of the solution of the present disclosure.

ADS liquid crystal displays are widely used due to their wide viewing angles. However, the ADS liquid crystal displays are very sensitive to the disordered arrangement of liquid crystals when in a Normal Black state. Moreover, as time goes on, displays are required to be thin, cheap, high quality, etc., so strict test requirements and the weak system design are increasingly impacting the displays. When a liquid crystal display is subjected to an extrusion deformation, a spacer (for example, a Photo Spacer (PS)) in the black matrix (BM) region may scratch the Polyimide (PI) Layer (orientation layer) at the edge of the pixel region on the CF substrate side. When the display is in the black state, no voltage is applied to the common electrode and the pixel electrode (no electric field). At this time, at the edge of the pixel region, the liquid crystal arrangement will be disordered due to the scratched PI, and bad display effects such as blue spots and colorful spots will occur at this position.

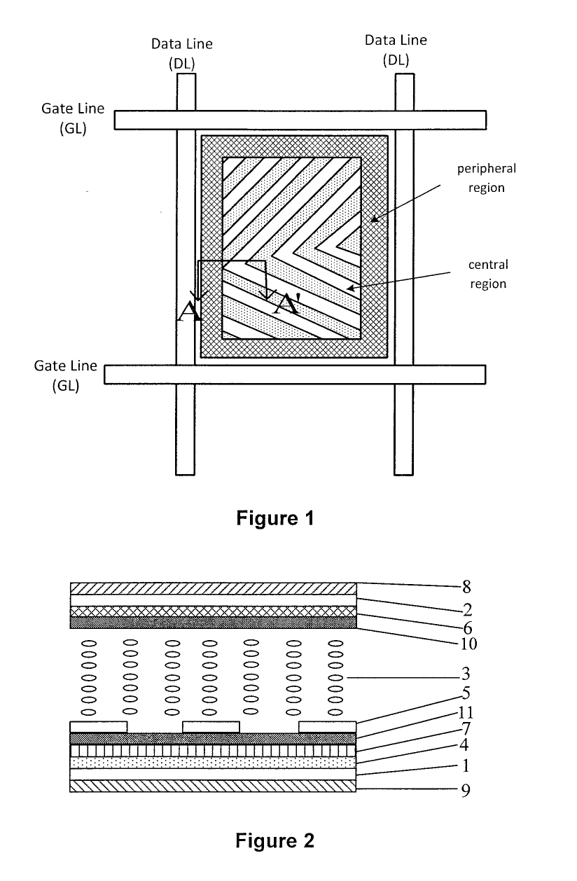

As shown in both FIGS. 1 and 2, an embodiment of the present disclosure provides a display panel including a first substrate 1 and a second substrate 2 disposed opposite to each other, and a liquid crystal layer 3 disposed between the first substrate 1 and the second substrate 2. Gate lines, GLs, and data lines, DLs, intersect to define pixel regions.

The first substrate 1 is divided into a plurality of pixel regions, and the pixel region includes a central region and a peripheral region. A first electrode 4 and a second electrode 5 are sequentially disposed on a surface of the first substrate 1 facing the liquid crystal layer 3 in a direction from the first substrate 1 to the liquid crystal layer 3. The first electrode 4 and the second electrode 5 are configured to form an electric field under a voltage to drive liquid crystal molecules in the liquid crystal layer 3 to deflect. An edge electrode 6 is disposed on the second substrate 2, and the orthographic projection of the edge electrode 6 on the first substrate 1 at least partially overlaps the peripheral region.

The display panel of the present embodiment is provided with the edge electrode 6 on the second substrate 2, and the orthographic projection of the edge electrode 6 on the first substrate 1 at least partially overlaps the peripheral region. Therefore, when the display panel is in a normal gray scale display state, a first voltage is applied to the first electrode 4, and a second voltage is applied to the second electrode 5, where the difference between the first voltage and the second voltage is the display voltage. A voltage same as the voltage applied to first electrode 4 is applied to the edge electrode 6, in order to prevent an electric field from being formed between the first electrode 4 and the edge electrode 6 to affect the electric field formed between the first electrode 4 and the second electrode 5, which otherwise would affect the normal display of the display panel. When the display panel is in a black display (L0 display) state, the voltages applied to the first electrode 4 and the second electrode 5 on the first substrate 1 are the same, that is, the relative voltage between the first electrode 4 and the second electrode 5 is 0 V. At this time, a driving voltage, which is different from those applied to the first electrode 4 and the second electrode 5, may be applied to the edge electrode 6, thereby a vertical electric field is formed between the edge electrode 6 and the first electrode 4, and the liquid crystal molecules at the position where the edge electrode 6 is located are vertically arranged. If the light absorption axes of the upper polarizer 8 and the lower polarizer 9 of the display panel are perpendicular to each other, the display panel can also realize a black display state at the position where the edge electrode 6 is located, thereby effectively solving the problem of blue spots in the surrounding regions of the pixel regions of the display panel due to scratches of the PI layer during the extrusion test.

Particularly, in the display panel of the present embodiment, the edge electrode 6 is configured to be applied with the same voltage as the first electrode 4 when the display panel is in a gray scale display state; and the edge electrode 6 is configured to be applied with a voltage different from the first electrode 4 when the display panel is in a black display state.

In this embodiment, the first substrate 1 may be an array substrate, and the corresponding second substrate 2 is a color film substrate. Gate line, GLs, and data lines, DLs on the first substrate 1 (shown in FIG. 1) intersect to define pixel regions, and the color filter substrate 2 is provided with a color filter and a black matrix. Generally, the color filter is arranged to correspond to a pixel region, and the orthographic projection of the black matrix on the first substrate is between adjacent pixel regions, so as to prevent light leakage at the positions of the gate lines and the data lines on the array substrate, which may result in a poor display. A spacer is located in the area where the black matrix is located to avoid occupying the position of the display area and affecting the aperture ratio of the display panel. In this embodiment, the edge electrode 6 is disposed on a side of the black matrix near the central region; and the spacing between the edge electrode 6 and the black matrix is 0˜60 μm. The purpose of such an arrangement is to ensure that the liquid crystal molecules in the surrounding region of the pixel regions can be vertically arranged as much as possible in the black display state to alleviate the problem of blue spots.

In the embodiment, the first electrode 4 on the first substrate 1 is a plate electrode, and the second electrode 5 is a strip electrode. Thereby, a liquid crystal coplanar switching electric field can be formed when voltages are applied to the first electrode 4 and the second electrode 5, to drive the liquid crystal molecules to deflect so as to realize the display. Of course, according to an embodiment of the present disclosure, an insulating layer 7 is further disposed between the first electrode 4 and the second electrode 5. The insulating layer 7 has a thickness of 0.1 to 1 μm, and its material includes a mixture of Barium Titanate and Polyimide. The content of the Barium Titanate in the mixture is 50%, and the dielectric constant of the mixture is 30. The Material with a high dielectric constant (e.g., a dielectric constant greater than 3.7) can improve the electric field utilization and reduce the driving voltage, thereby reducing the power consumption.

It should be noted here that both the first electrode 4 and the second electrode 5 may be trip electrodes. When strip electrodes are used, the first electrode 4 and the second electrode 5 can be arranged in the same layer or in different layers. When they are arranged in the same layer, the strip electrodes thereof can be alternately arranged.

In this embodiment, the edge electrode 6 (its orthographic projection on the first substrate) may not only partially overlap the peripheral regions of the pixel regions of the display panel, but also cover the whole pixel regions. For example, the edge electrode 6 may be a plate electrode, of which the orthographic projection on the first substrate covers the pixel regions. The operation principle in this case is the same as the foregoing principle and will not be described in detail.

In the present embodiment, the materials of the first electrode 4, the second electrode 5, and the edge electrode 6 are all transparent conductive materials, such as ITO (Indium Tin Oxide). Of course, it is not limited to such kind of material.

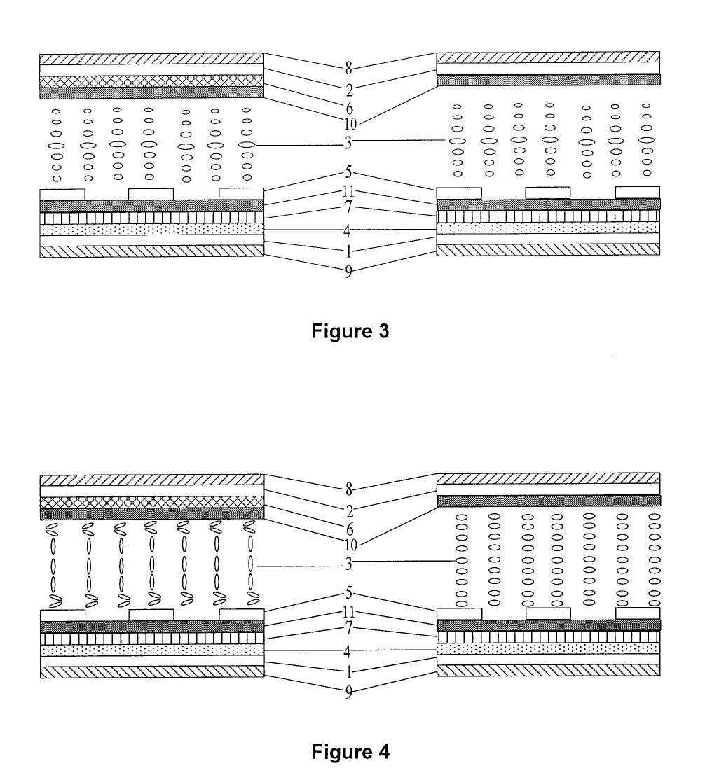

The display panel structure of the present embodiment may be used in an ADS display mode, and an edge electrode 6 is provided on the second substrate 2 in order to alleviate the problem of blue spots in the surrounding regions of the pixel regions of the display panel occurred in the black display state. FIG. 3 is a schematic diagram of a display panel in a normal display state according to an embodiment of the present disclosure. FIG. 3 shows a schematic diagram of liquid crystals at the peripheral region (left side in FIG. 3) and at the central region (right side in FIG. 3) of the pixel regions in a normal display state (displaying a non-black display screen). For the peripheral region of the pixel regions, a relative voltage of 0 V is applied between the edge electrode 6 on the second substrate 2 and the first electrode 4 on the first substrate 1, and a Von voltage is applied to the second electrode 5 on the first substrate 1. Since the distance between the second electrode 5 and the first electrode 4 is much smaller than the distance between the second electrode 5 and the edge electrode 6, the horizontal electric field formed by the second electrode 5 and the first electrode 4 is much larger than the vertical electric field formed by the second electrode 5 and the edge electrode 6. Further, when the second electrode 5 is a strip electrode as shown in FIG. 3, the formed vertical electric field exists only in a region corresponding to the strip electrode, and has little influence on the display panel. Thus, when the display panel displays a non-black display screen, a liquid crystal coplanar switching electric field is formed between the first electrode 4 and the second electrode 5, which drives the liquid crystal molecules to deflect so as to realize the display. The liquid crystals driven at the peripheral region of the pixel regions and the liquid crystals driven at the central region are the same, which are both in a normal ADS display mode when the display panel is in a normal gray scale display state.

FIG. 4 is a schematic diagram of a display panel in a black display state according to an embodiment of the present disclosure. FIG. 4 shows a schematic diagram of liquid crystals at the peripheral region (left side in FIG. 4) and at the central region (right side in FIG. 4) of the pixel regions in a black display state. When the display panel displays a black display screen, a driving voltage Vx is applied to the edge electrode 6 on the second substrate 2 corresponding to the peripheral region of the pixel regions, and a relative voltage of 0 V is applied between the first electrode 4 and the second electrode 5 on the first substrate 1. Therefore, when the display panel displays a black display screen, the edge electrode 6 and the first electrode 4 act to apply a longitudinal vertical electric field to the liquid crystals in the peripheral region of the pixel regions, and the liquid crystal molecules are vertically arranged in accordance with the electric field (as shown on the left side of FIG. 4). When the light absorption axes of the upper polarizer 8 and the lower polarizer 9 are perpendicular to each other, the display panel also displays a black display screen at the peripheral region. The central region of the pixel regions is in a normal ADS display mode design. When the display panel displays a black display screen, a relative voltage of 0 V is applied between the first electrode 4 and the second electrode 5 of the first substrate 1, and the liquid crystal molecules are arranged along the rubbing orientation of PI, so as to display a black screen. It is also shown in FIG. 4 that the liquid crystal molecules immediately adjacent to the orientation layers 10 and 11 will have the same orientation as the orientation layers due to the anchoring effect of the orientation layers, while the liquid crystal molecules far away from the orientation layers are subjected to the vertical electric field, and have a vertical orientation.

As shown in FIGS. 3 and 4, the display panel according to an embodiment of the present disclosure further comprises: a first polarizer 8 and a second polarizer 9 respectively disposed on a side of the first substrate and a side of the second substrate opposite to the liquid crystal layer, wherein the first polarizer 8 and the second polarizer 9 have light absorption axes that are perpendicular to each other.

As further shown in FIGS. 3 and 4, the display panel according to an embodiment of the present disclosure further comprises: a first orientation layer 10 and a second orientation layer 11 in contact with the liquid crystal layer, wherein the first orientation layer 10 is disposed on a side of the second substrate 2 facing the liquid crystal layer, the second orientation layer 11 is disposed on a side of the first substrate 1 facing the liquid crystal layer. The orientations of the first orientation layer and the second orientation layer are parallel.

Another embodiment of the present disclosure provides a display apparatus including a display panel according to an embodiment of the present disclosure. The display apparatus according to an embodiment of the present disclosure has the same effects as the above-described display panel, and details thereof are not described herein again.

The display apparatus may be any product or component having a display function, such as a mobile phone, a tablet computer, a television set, a monitor, a notebook computer, a digital photo frame, a navigator, or the like.

Of course, the display apparatus of the embodiment may further include other conventional components, such as a power supply unit, a display driving unit, and the like.

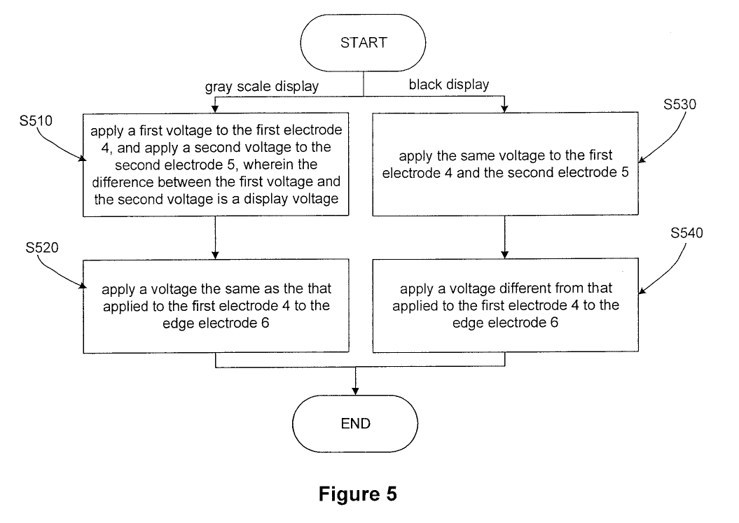

Yet another embodiment of the present disclosure provides a driving method for driving the display panel according to an embodiment of the present disclosure. FIG. 5 shows a flow chart of a driving method according to an embodiment of the present disclosure. As shown in FIG. 5, at step S510, a first voltage is applied to the first electrode 4 and a second voltage is applied to the second electrode 5 when the display panel is in a gray scale display state, wherein the difference between the first voltage and the second voltage is a display voltage. In order not to affect the normal gray scale display of the display panel, the method further includes the step S520 of applying to the edge electrode 6 a voltage same as the voltage applied to the first electrode 4, that is, the first voltage. As described above, the display panel of the present embodiment is provided with an edge electrode 6 on the second substrate 2, and the orthographic projection of the edge electrode 6 on the first substrate 1 at least partially overlaps the peripheral region. Therefore, applying to the edge electrode 6 a voltage same as the voltage applied to the first electrode 4 can prevent an electric field from being formed between the first electrode 4 and the edge electrode 6, which otherwise would destroy the electric field formed between the first electrode 4 and the second electrode 5 and affect the normal display of the display panel.

As shown in FIG. 5, the driving method according to an embodiment of the present disclosure further includes a step S530 of applying the same voltage to the first electrode and the second electrode when the display panel is in a black display state, that is, a relative voltage of 0V is applied between the first electrode 4 and the second electrode 5, so that the display panel displays a black display screen. In this case, the method further includes a step S540 of applying to the edge electrode 6 a voltage different from that applied to the first electrode 4, such as a driving voltage Vx. Thus, a longitudinal vertical electric field is applied to the liquid crystals in the peripheral region of the pixel regions, and the liquid crystal molecules are vertically arranged in accordance with the electric field. When the light absorption axes of the upper polarizer 8 and the lower polarizer 9 are perpendicular to each other, the display panel also displays a black display screen at the peripheral region.

It is to be understood that the above implementations are merely illustrative embodiments for the purpose of illustrating the principles of the present disclosure, but the present disclosure is not limited thereto. It will be apparent to those skilled in the art that various changes and modifications can be made therein without departing from the spirit and essence of the present disclosure, which are also considered to be within the protection scope of the present disclosure.

1. A display panel, comprising:
a first substrate and a second substrate disposed opposite to each other, and a liquid crystal layer disposed between the first substrate and the second substrate; wherein the first substrate is divided into a plurality of pixel regions, and the pixel regions include a central region and a peripheral region, a first electrode and a second electrode are sequentially disposed on a surface of the first substrate facing the liquid crystal layer in a direction from the first substrate to the liquid crystal layer; the first electrode and the second electrode are configured to form an electric field under a voltage to drive liquid crystal molecules in the liquid crystal layer to deflect; and
an edge electrode disposed on the second substrate, wherein the orthographic projection of the edge electrode on the first substrate at least partially overlaps the peripheral region.

2. The display panel of claim 1, wherein:
the edge electrode is configured to be applied with the same voltage as the first electrode when the display panel is in a gray scale display state; and
the edge electrode is configured to be applied with a voltage different from the first electrode when the display panel is in a black display state.

3. The display panel of claim 1, further comprises: a black matrix disposed on the second substrate, wherein the orthographic projection of the black matrix on the first substrate is between adjacent pixel regions, and the edge electrode is located on a side of the black matrix near the central region; and the spacing between the edge electrode and the black matrix is 0˜60 μm.

4. The display panel of claim 1, wherein the first electrode is a plate electrode, and the second electrode is a strip electrode.

5. The display panel of claim 1, wherein the edge electrode is a plate electrode.

6. The display panel of claim 1, wherein an insulating layer is further disposed between the first electrode and the second electrode.

7. The display panel of claim 6, wherein the insulating layer has a thickness of 0.1˜1 μm.

8. The display panel of claim 6, wherein the insulating layer is a dielectric having a dielectric constant greater than 3.7.

9. The display panel of claim 6, wherein the insulating layer is made of a material comprising a mixture of Barium Titanate and Polyimide.

10. The display panel of claim 1, further comprises: a first polarizer and a second polarizer respectively disposed on a side of the first substrate and a side of the second substrate opposite to the liquid crystal layer, wherein the first polarizer and the second polarizer have light absorption axes that are perpendicular to each other.

11. The display panel of claim 1, further comprises: a first orientation layer and a second orientation layer in contact with the liquid crystal layer, wherein the first orientation layer is disposed on a side of the second substrate facing the liquid crystal layer, the second orientation layer is disposed on a side of the first substrate facing the liquid crystal layer, and wherein the first orientation layer and the second orientation layer have parallel orientations.

12. The display panel of claim 1, wherein the edge electrode further covers the pixel regions.

13. The display panel of claim 1, wherein the edge electrode is made of a material comprising ITO.

14. The display panel of claim 1, wherein the first substrate is an array substrate, and the second substrate is a color filter substrate.

15. A display apparatus comprising the display panel of claim 1.

16. A driving method for driving the display panel of claim 1, the driving method comprises, when the display panel is in a gray scale display state:
applying a first voltage to the first electrode and applying a second voltage to the second electrode, wherein the difference between the first voltage and the second voltage is a display voltage; and
applying the first voltage to the edge electrode.

17. The driving method of claim 16, further comprising,
when the display panel is in a black display state:
applying the same voltage to the first electrode and the second electrode; and
applying, to the edge electrode, a voltage different from the voltage applied to the first electrode.

18. The display panel of claim 2, further comprises: a black matrix disposed on the second substrate, wherein the orthographic projection of the black matrix on the first substrate is between adjacent pixel regions, and the edge electrode is located on a side of the black matrix near the central region; and the spacing between the edge electrode and the black matrix is 0˜60 μm.

19. The display panel of claim 2, further comprises: a first polarizer and a second polarizer respectively disposed on a side of the first substrate and a side of the second substrate opposite to the liquid crystal layer, wherein the first polarizer and the second polarizer have light absorption axes that are perpendicular to each other.

20. The display panel of claim 2, further comprises: a first orientation layer and a second orientation layer in contact with the liquid crystal layer, wherein the first orientation layer is disposed on a side of the second substrate facing the liquid crystal layer, the second orientation layer is disposed on a side of the first substrate facing the liquid crystal layer, and wherein the first orientation layer and the second orientation layer have parallel orientations.
